(19) United States
(12) Patent Application Publication
(10) Pub. No.: US 2011/0316439 A1
(43) Pub. Date: Dec. 29, 2011

(54) LIGHT EMITTING DEVICE

(75) Inventors: Jui-Ying Lin, Taipei City (TW); Wen-Yung Yeh, Hsinchu County (TW); Chwung-Shan Kou, Hsinchu City (TW)

(73) Assignees: NATIONAL TSING HUA UNIVERSITY, Hsinchu City (TW); INDUSTRIAL TECHNOLOGY RESEARCH INSTITUTE, Hsinchu (TW)

(21) Appl. No.: 13/165,743

(22) Filed: Jun. 21, 2011

Related U.S. Application Data
(60) Provisional application No. 61/359,358, filed on Jun. 29, 2010.

(51) Int. Cl. H05B 41/16

(52) U.S. Cl. 315/250

(57) ABSTRACT

A light emitting device includes a first power node and a second power node configured to receive single-phase voltage provided from an AC voltage source, a first light emitting unit including at least one light emitting diode (LED), wherein a first end of the first light emitting unit is coupled to the first power node, a second light emitting unit including at least one LED, wherein a first end of the second light emitting unit is coupled to the first power node, and a second end of the second light emitting unit couples to the second power node, and a first phase modulator coupled between a second end of the first light emitting unit and the second power node and configured to change the phase of the single-phase voltage provided to the first light emitting unit.

### CROSS-REFERENCE TO RELATED APPLICATION

This application claims the priority benefit of provisional application Ser. No. 61/359,358, filed on Jun. 29, 2010. The entirety of the above-mentioned provisional application is hereby incorporated by reference herein and made a part of this specification.

### BACKGROUND

1. Technical Field

The present disclosure relates to a light emitting device and, more particularly, to a light emitting device that can cover all the off-period of light emitting diodes in the light emitting device and result in a light source without flickering and power deteriorating.

2. Related Art

Light emitting diodes (LEDs) exhibit common characteristics of diodes that are turned on to emit light upon application of a forward threshold voltage and turned off otherwise. Moreover, two or more LEDs may be coupled in inverse parallel with each other in order to increase a light emitting region upon application of an AC voltage source. The coupled LEDs are referred to as an alternating-current (AC) LED, of which in a positive half-period of the AC voltage source, the AC LED is turned on by application of a forward threshold voltage or more to the LEDs coupled to each other in the forward direction with respect to the positive half-period of the voltage, and in a negative half-period of the AC voltage source, the AC LED is turned on by application of a forward threshold voltage or more to the LEDs coupled to each other in the forward direction with respect to the negative half-period of the voltage.

However, since each of the LEDs of the AC voltage source has a short operating region (on-period), it causes a problem of deterioration in optical efficiency of the AC LED by severe flickering. As can be seen, the problem may become severe when multiple AC LEDs are coupled in series.

FIG. 1 is a plot illustrating the on-period and the off-period of the conventional AC LED. Referring to FIG. 1, when the positive half-period (e.g., an on-period 1-1 shown in FIG. 1) of the AC voltage source, the LEDs coupled to each other in the forward direction with respect to the positive half-period of the voltage will be turned on. Similarly, when a negative half-period (e.g., an on-periods 1-2 or 1-3) of the AC voltage source, the LEDs coupled to each other in the forward direction with respect to the negative half-period of the voltage will be turned on. Otherwise, when off-periods 1-4 or 1-5, the LEDs in the conventional AC LED will be turned off since none of them works at an operating voltage below the threshold voltage. Therefore, the AC LED suffers the flickering problem that it is turned on and off alternately under the above-mentioned operating conditions as the on- and off-period exchanges alternately.

To solve the flickering problem, conventionally higher operating frequency or multi-phase solutions may be applied. The solutions may include using a voltage source having operating frequency greater than 60 Hz (e.g., 180 Hz), or a multi-phase voltage source.

FIG. 2 is a diagram illustrating a conventional AC LED that applies a three-phase power source 2. In this design, since the phase of LEDs of the AC LED 2-1, 2-2 and 2-3 are designed to be different to each other, a part of the LEDs that are under the off-period (i.e., no light is emitted) can be covered by other part of the LEDs that are under the on-period. However, the conventional solutions may need extra power supplies (voltage sources). Also, the higher operating frequency may cause extra loading to the voltage sources, and thus jeopardizes the advantage of the AC-LED.

Therefore, it is desirable to have a light emitting device or a driving circuit thereof that can solve the flickering problem when applying a AC LED without deteriorating the power factor of the light emitting device.

### SUMMARY

Exemplary embodiments of the present disclosure provide a light emitting device. The light emitting device includes a first light emitting unit, a second light emitting unit and a first phase modulator. The first light emitting unit comprises at least one alternating-current (AC) light emitting diode (LED), wherein the first light emitting unit is coupled to an AC voltage source. The second light emitting unit comprises at least one AC LED, wherein a first end of the second light emitting unit is coupled to the AC voltage source, and the second light emitting unit couples to the first light emitting unit in parallel. The first phase modulator and the first light emitting unit couple to the AC voltage source in series, the first phase modulator is configured to change the phase of a voltage provided to the first light emitting unit, and the phase of the voltage provided to the first light emitting unit is different from the phase of a voltage provided to the second light emitting unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a plot of a single-phase AC voltage of a conventional AC LED.

FIG. 2 is a diagram illustrating a conventional AC LED that applies a three-phase power source.

FIG. 3 is a diagram illustrating a light emitting device according to an exemplary embodiment of the present disclosure.

FIG. 4A is a diagram illustrating a light emitting unit according to an exemplary embodiment of the present disclosure.

FIG. 4B is a diagram illustrating a light emitting unit according to another exemplary embodiment of the present disclosure.

FIG. 4C is a diagram illustrating a light emitting unit according to still another exemplary embodiment of the present disclosure.

FIG. 4D is a diagram illustrating a light emitting unit according to other exemplary embodiment of the present disclosure.

FIG. 5A is a diagram illustrating a phase modulator according to an exemplary embodiment of the present disclosure.

FIG. 5B is a diagram illustrating a phase modulator according to another exemplary embodiment of the present disclosure.

FIG. 5C is a diagram illustrating a phase modulator according to still another exemplary embodiment of the present disclosure.

FIG. 5D is a diagram illustrating a phase modulator according to other exemplary embodiment of the present disclosure.

FIG. 6 is a diagram illustrating a light emitting device according to another exemplary embodiment of the present disclosure.

FIG. 7 is a diagram illustrating the light emitting device according to still another exemplary embodiment of the present disclosure.

FIG. 8 is a diagram illustrating a light emitting device according to still another exemplary embodiment of the present disclosure.

FIG. 9 is a diagram illustrating a light emitting device according to still another exemplary embodiment of the present disclosure.

FIG. 10A is a diagram illustrating the light emitting device according to still another exemplary embodiment of the present disclosure.

FIG. 10B is a diagram illustrating a light emitting device of FIG. 10A according to an exemplary embodiment of the present disclosure.

FIG. 11 is a diagram illustrating a light emitting device according to still another exemplary embodiment of the present disclosure.

FIG. 12 is a diagram illustrating the light emitting device according to other exemplary embodiment of the present disclosure.

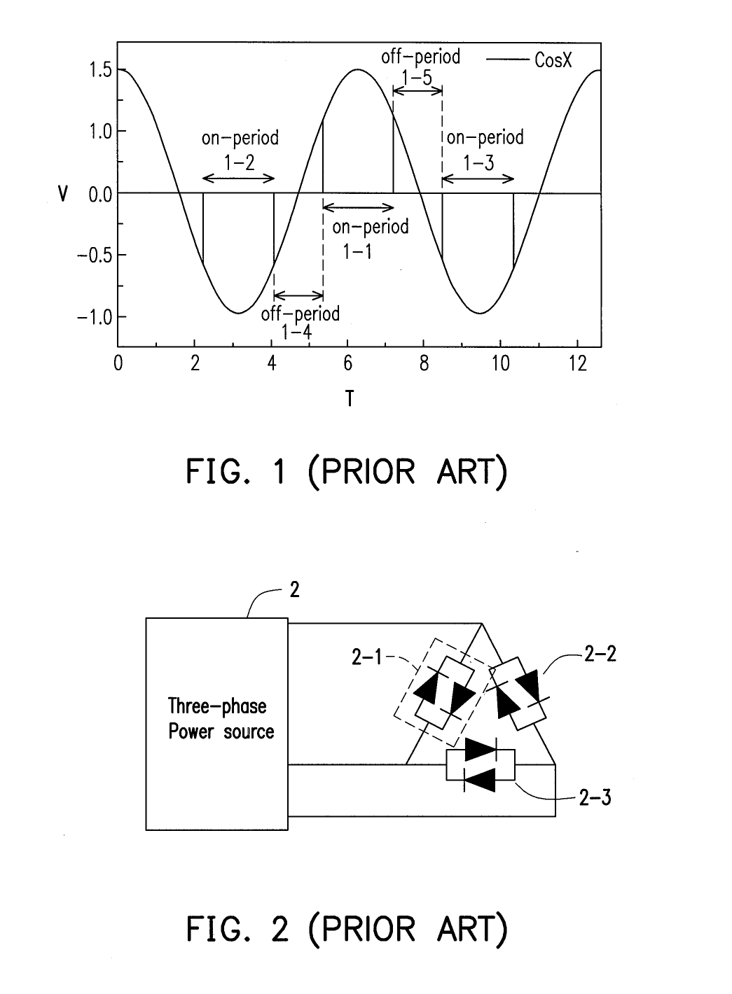

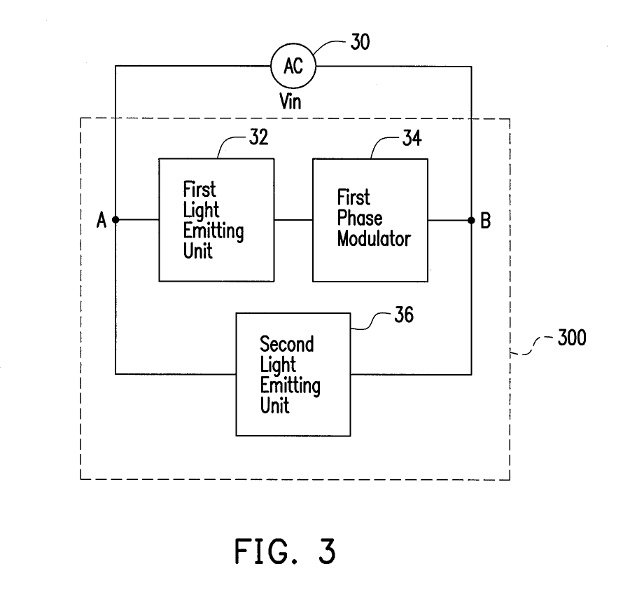

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

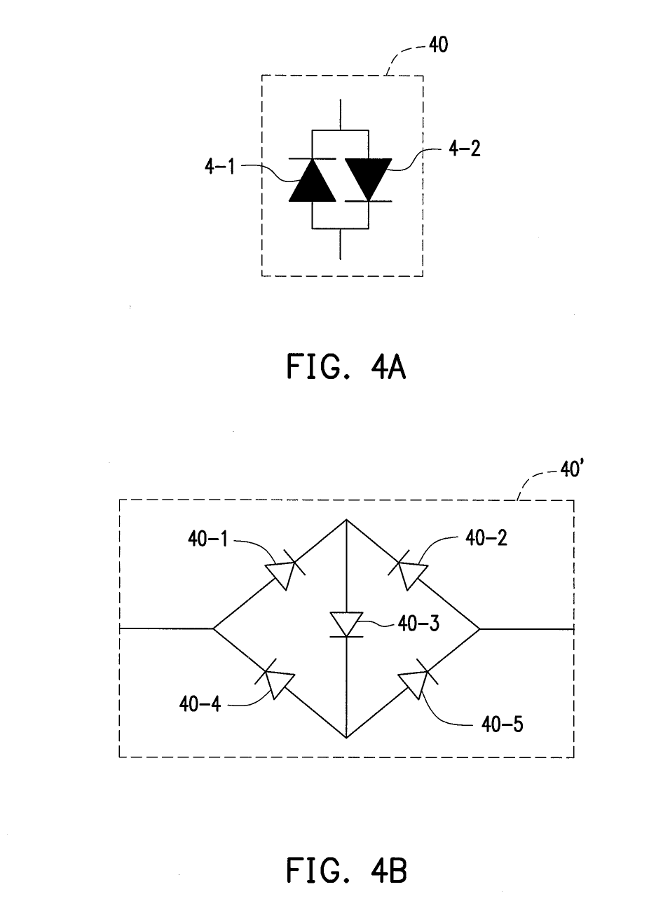

FIG. 3 is a diagram illustrating a light emitting device 300 according to an exemplary embodiment of the present disclosure. Referring to FIG. 3, the light emitting device 300 may include a first power node A, a second power node B, a first light emitting unit 32, a first phase modulator 34 and a second light emitting unit 36. An AC voltage source 30 may provide a single-phase voltage to the light emitting device 300. The first power node A and the second power node B are configured to receive the single-phase voltage provided from the AC voltage source 30. The first light emitting unit 32 and the second light emitting unit 36 may be coupled in parallel with each other, and each of the first light emitting unit 32 and the second light emitting unit 36 may include at least one alternating-current (AC) light emitting diode (LED). The first phase modulator 34 and the first light emitting unit 32 couple to the AC voltage source 30 in series. The first phase modulator 34 is configured to change the phase of a voltage provided to the first light emitting unit 32. Wherein, the phase of the voltage provided to the first light emitting unit 32 is different from the phase of a voltage provided to the second light emitting unit 36.

For example, a first end of the first light emitting unit 32 is coupled to the first power node A. The first phase modulator 34 is connected between a second end of the first light emitting unit 32 and the second power node B. Moreover, a first end of the second light emitting unit 36 is coupled to the first power node A, and a second end of the second light emitting unit 36 couples to the second power node B.

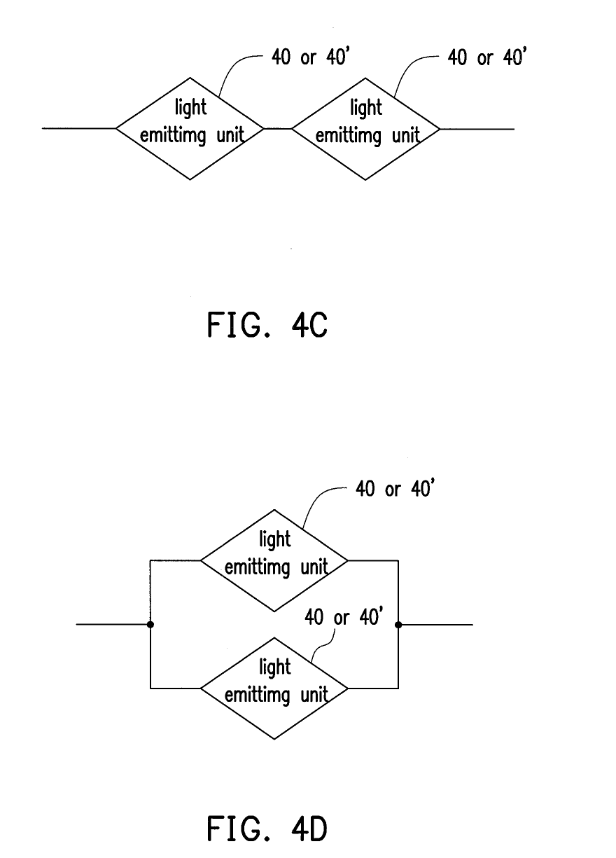

The aforementioned light emitting units 32 and 36 may include a variety of elements. FIG. 4A is a diagram illustrating a light emitting unit 40 according to an exemplary embodiment of the present disclosure. Referring to FIG. 4A, the light emitting unit 40 may include two LEDs 4-1 and 4-2 coupled in inverse parallel as an AC LED. The light emitting unit 40 of FIG. 4A can be the first light emitting unit 32 and/or the second light emitting unit 36 described in the FIG. 3.

FIG. 4B is a diagram illustrating a light emitting unit 40′ according to another exemplary embodiment of the present disclosure. Referring to FIG. 4B, the light emitting unit 40 may include a LED bridge comprising LEDs 40-1, 40-2, 40-3, 40-4 and 40-5 coupled as the Wheatstone bridge as an AC LED. The LEDs 40-1, 40-3 and 40-5 will be turned on if a forward voltage applied to the light emitting unit 40′, and similarly the LEDs 40-2, 40-3 and 40-4 will be turned on if a backward voltage applied to the light emitting unit 40′. The light emitting unit 40′ of FIG. 4B can be the first light emitting unit 32 and/or the second light emitting unit 36 described in the FIG. 3.

Moreover, FIGS. 4C and 4D are a diagrams illustrating a light emitting unit according to still another exemplary embodiment of the present disclosure, wherein the light emitting unit may include a plurality of light emitting units 40 and/or 40′ coupled in series or parallel. The light emitting unit of FIG. 4C or 4D can be the first light emitting unit 32 and/or the second light emitting unit 36 described in the FIG. 3.

Furthermore, the first phase modulator 34 may be coupled in series with the first light emitting unit 32, that is, between a second end of the first light emitting unit 32 and the second power node B, and configured to change the phase of the single-phase voltage provided to the light emitting unit 32. Also in this embodiment, the first phase modulator 34 is coupled in series with the first light emitting unit 32 and in parallel with the second light emitting unit 36.

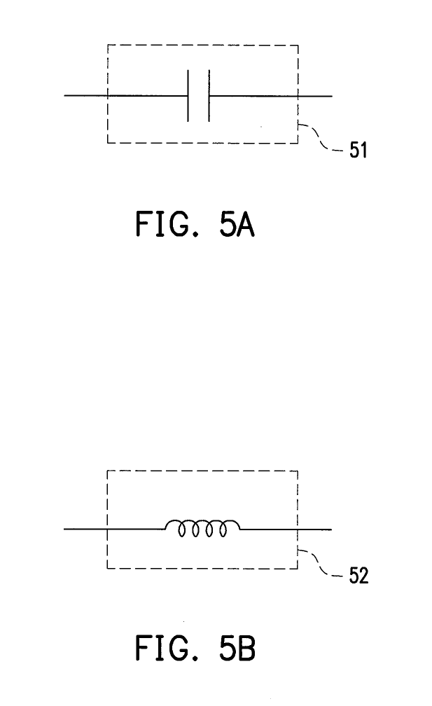

The aforementioned phase modulator 34 may be a variety of elements, such as resistors, capacitors, inductors, and the like. Moreover, the first phase modulator 34 may be a capacitor and an inductor coupled in parallel or in series. For example, FIG. 5A is a diagram illustrating a phase modulator 51 according to an exemplary embodiment of the present disclosure. The phase modulator 51 includes a capacitor. The phase modulator 51 can be the first phase modulator 34 described in the FIG. 3. Referring to FIG. 3, those skilled in the art can easily understand that the light emitting units 32 and 36 can be modelled as resistors having resistance R and the first phase modulator 34 may be modelled as a capacitor having capacitance C. The impedance of the capacitance is Zc=1/(jωC). In this embodiment, the first phase modulator 34 is capable of providing a positive phase shift voltage from the single-phase voltage. The total impedance of the equivalent circuit can be calculated as:

$$total impedance = {Z}_{T} = R + \frac{1}{j ω C} = R - jX , and$$

$${V}_{R} = \frac{R}{{Z}_{T}} {V}_{in} = \frac{{RV}_{in}}{R - jX}$$

When X equals to R, the above equation can be deduced as follows:

$${V}_{R} = \frac{{V}_{in}}{\sqrt{2}} exp ( i π \text{/} 4 )$$

It can be concluded that the voltage having a phase shift of π/4 (i.e. 45°) is applied to the first light emitting unit 32 because of the first phase modulator 34. Therefore, there is a positive phase shift between the input voltage Vin and the voltage across the first light emitting unit 32 when C=1/(ωR). Therefore, since the phase of first light emitting unit 32 and the second light emitting unit 36 are designed to be different each other, one of the light emitting units 32 and 36 that is under the off-period (i.e., no light is emitted) can be covered by the other of the light emitting units 32 and 36 that are under the on-period.

FIG. 5B is a diagram illustrating a phase modulator 52 according to another exemplary embodiment of the present disclosure. The phase modulator 52 includes a inductor. The phase modulator 52 can be the first phase modulator 34 described in the FIG. 3. Referring to FIG. 3, the first light emitting unit 32 may be modelled as a resistor having resistance R and the first phase modulator 34 may be modelled as an inductor having inductance L. The impedance of the inductance is Z_{L}=jωL. In this embodiment, the first phase modulator 34 is capable of providing a negative phase shift voltage from the single-phase voltage. The total impedance of the equivalent circuit can be calculated as:

$$total impedance = {Z}_{T} = R + j ω L = R + jX , and \\ {V}_{R} = \frac{R}{{Z}_{T}} {V}_{in} = \frac{{RV}_{in}}{R - jX}$$

When X equals to R, the above equation can be deduced as follows:

$${V}_{R} = \frac{{V}_{in}}{\sqrt{2}} exp ( i π \text{/} 4 )$$

That is, the voltage having a phase shift of −π/4(i.e. −45°) is applied to the first light emitting unit 32. Therefore, there is a negative phase shift between the input voltage Vin and the voltage across the first light emitting unit 32 when L=R/ω. Therefore, since the phase of first light emitting unit 32 and the second light emitting unit 36 are designed to be different to each other, one of the light emitting units 32 and 36 that is under the off-period (i.e., no light is emitted) can be covered by the other of the light emitting units 32 and 36 that are under the on-period.

FIG. 5C is a diagram illustrating a phase modulator 53 according to still another exemplary embodiment of the present disclosure. The phase modulator 53 includes a capacitor and an inductor. The capacitor connects to the inductor in parallel. The phase modulator 53 can be the first phase modulator 34 described in the FIG. 3. FIG. 5D is a diagram illustrating a phase modulator 54 according to other exemplary embodiment of the present disclosure. The phase modulator 54 includes a capacitor and an inductor. The capacitor connects to the inductor in series. The phase modulator 54 can be the first phase modulator 34 described in the FIG. 3.

Referring to FIG. 5C or 5D, those skilled in the art can easily understand that the impedance of the resonant LC circuits at its operating frequency can be tuned to be capacitive or inductive by making the resonance frequency greater or less than the operating frequency. Therefore, in some embodiments of the present disclosure, the phase modulator 53 and 54 can be used as reactive elements to tune the phase as described above. In these embodiments, off-periods of one of the light emitting units 32 and 36 can be cover by on-periods of another one of the light emitting units 32 and 36 since the phases of the voltages applied to them are shifted to different phases because of the phase modulator 53 or 54.

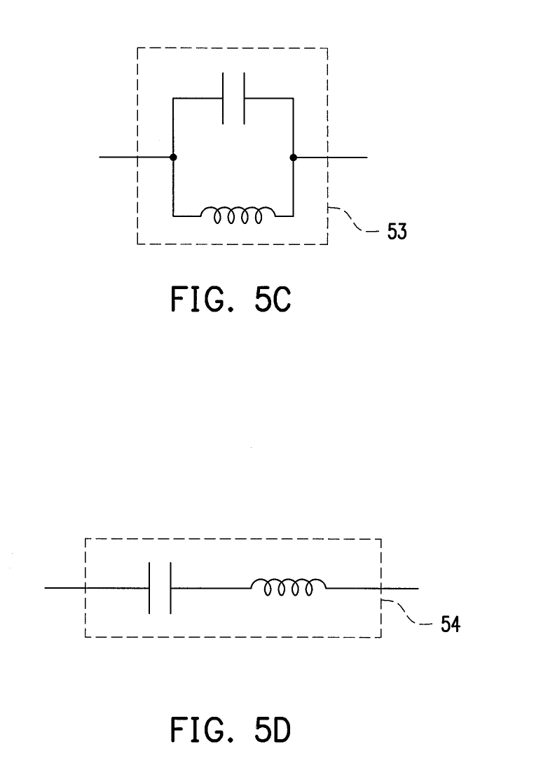

FIG. 6 is a diagram illustrating a light emitting device 600 according to another exemplary embodiment of the present disclosure. Referring to FIG. 6, the light emitting device 600 may be similar to those described or illustrated with reference to FIG. 3, except that, for example, the light emitting device 600 may further include a voltage divider 6 and a common node CN. The voltage divider 6 coupled between the first light emitting unit 32, the second light emitting unit 36 and the AC voltage source 30. The voltage divider 6 provides voltages divided from the single-phase voltage provided from the AC voltage source 30 to the first light emitting unit 32 and the second light emitting unit 36. In this embodiment, the voltage outputted from the voltage divider 6 to the first light emitting unit 32 may be same to the voltage outputted from the voltage divider 6 to the second light emitting unit 36. In other embodiment, the voltage outputted from the voltage divider 6 to the first light emitting unit 32 may be different to the voltage outputted from the voltage divider 6 to the second light emitting unit 36.

In this embodiment, for example, the common node CN is grounded or is coupled to other reference voltage. The voltage divider 6 is coupled to the AC voltage source 30, wherein the voltage divider 6 has at least two output ends for providing voltages divided from the single-phase voltage provided from the AC voltage source 30. The first light emitting unit 32 and the first phase modulator 34 are coupled between the common node CN and one of the at least two output ends of the voltage divider 6 in series. Moreover, the second light emitting unit 36 is coupled between the common node CN and another one of the at least two output ends of the voltage divider 6.

In one embodiment, the voltage divider 6 may comprise at least one of a resistor, a capacitor and an inductor. For example, the voltage divider 6 may comprise two impedance devices 61 and 62 (e.g. resistors, capacitors or inductors). For example, the impedance devices 61 and 62 are two capacitors. A first terminal of the impedance device 61 is coupled to the AC voltage source 30 and the first light emitting unit 32, and a second terminal of the impedance device 61 is coupled to the second light emitting unit 36. A first terminal of the impedance device 62 is coupled to the second terminal of the impedance device 61, and a second terminal of the impedance device 62 is coupled to the common node CN (e.g. grounded).

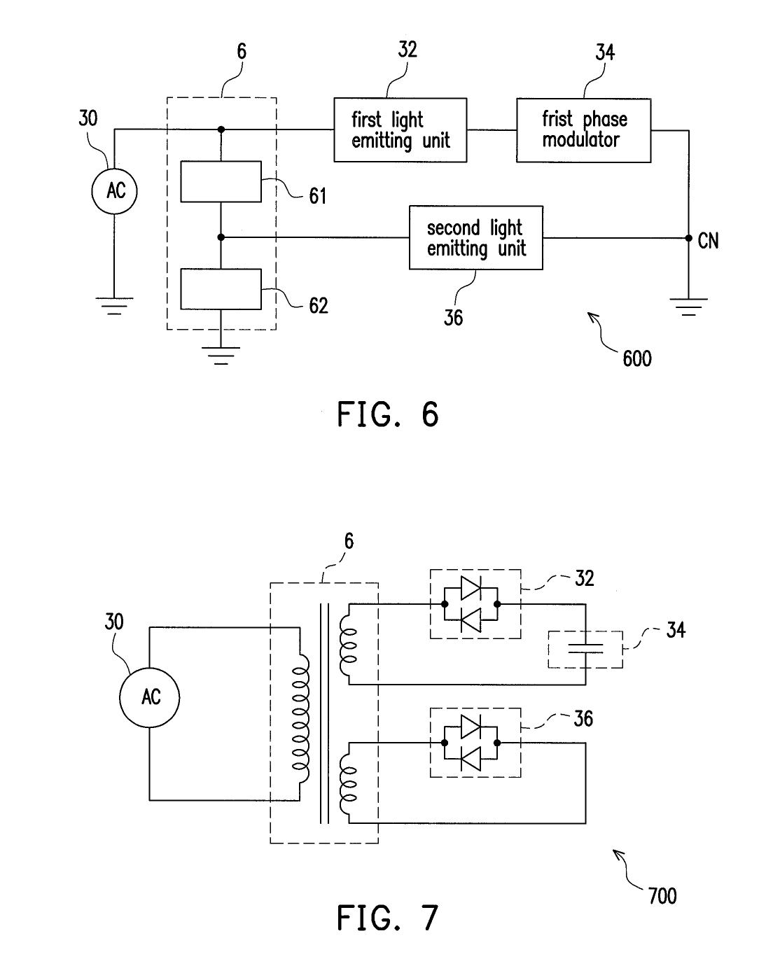

In another embodiment, the voltage divider 6 comprises a transformer for dividing the single-phase voltage provided from the AC voltage source 30. FIG. 7 is a diagram illustrating the light emitting device 700 according to still another exemplary embodiment of the present disclosure. The light emitting device 700 may be similar to those described or illustrated with reference to FIGS. 3 and 6. The voltage divider 6 comprises a transformer having a first winding, a second winding and a third winding. Two terminals of the first winding are coupled to the AC voltage source 30. The first light emitting unit 32 and the first phase modulator 34 are coupled between two terminals of the second winding in series. The second light emitting unit 36 is coupled between two terminals of the third winding.

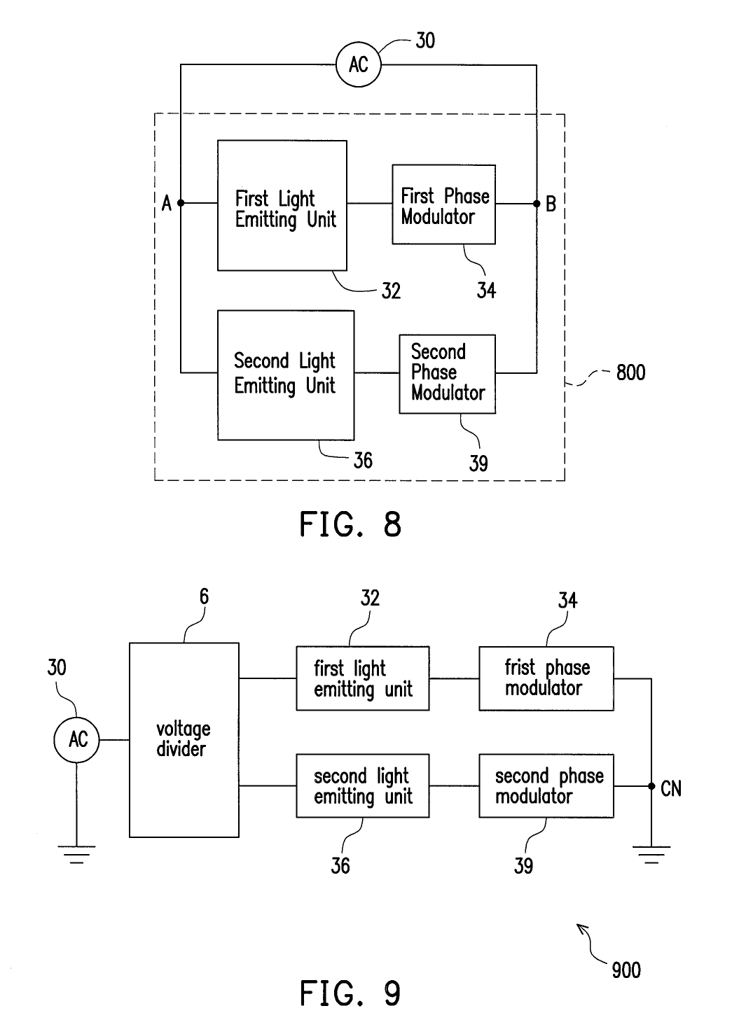

A second phase modulator 39 may also be coupled between the second end of the second light emitting unit 36 and the second power node B, and configured to change the phase of the voltage across the first light emitting unit 36 different from the phase of the voltage across the first light emitting unit 32. For example, FIG. 8 is a diagram illustrating a light emitting device 800 according to still another exemplary embodiment of the present disclosure. The light emitting device 800 of FIG. 8 may be similar to those described or illustrated with reference to FIG. 3. In FIG. 8, a second phase modulator 39 and the second light emitting unit 36 couple to the AC voltage source 30 in series. For example, the second phase modulator 39 is coupled between the second end of the second light emitting unit 36 and the second power node B. The second phase modulator 39 can change the phase of the voltage provided to the second light emitting unit 36. The second phase modulator 39 can be the phase modulators 51, 52, 53 or 54 described in the FIGS. 5A-5D.

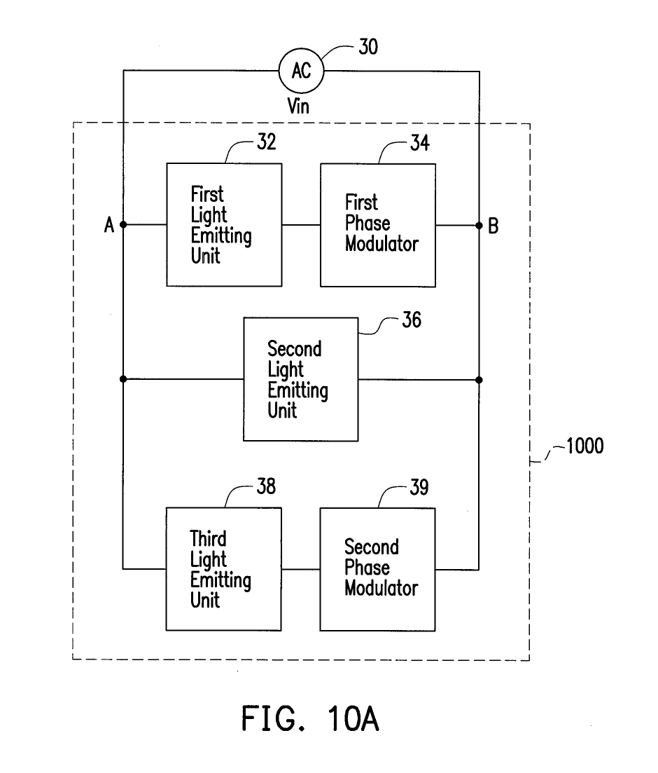

FIG. 9 is a diagram illustrating a light emitting device 900 according to still another exemplary embodiment of the present disclosure. The light emitting device 900 of FIG. 9 may be similar to those described or illustrated with reference to FIGS. 3, 6, 7 and 8. In FIG. 9, a second phase modulator 39 is coupled between the second end of the second light emitting unit 36 and the common node CN. The second phase modulator 39 can change the phase of the single-phase voltage provided to the second light emitting unit 36.

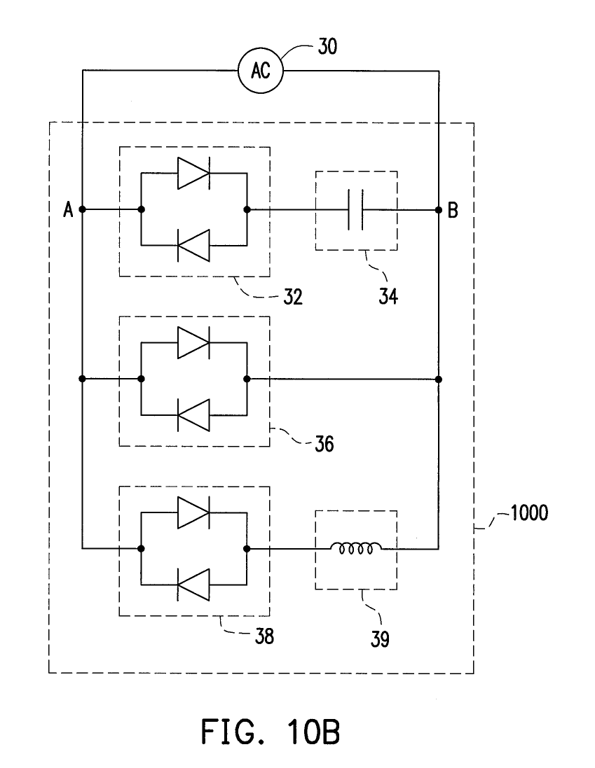

FIG. 10A is a diagram illustrating a light emitting device 1000 according to still another exemplary embodiment of the present disclosure. The light emitting device 1000 may be similar to those described or illustrated with reference to FIGS. 3, 6-9, except that, for example, the light emitting device 1000 may further include a third light emitting unit 38 and a second phase modulator 39. Referring to FIG. 10A, the third light emitting unit 38 may include at least one AC LED. For example, the third light emitting unit 38 can be the light emitting unit described in the FIG. 4A, 4B, 4C or 4D. The third light emitting unit 38 is coupled to the AC voltage source 30. The third light emitting unit 38 is coupled to the first light emitting unit 32 and the second light emitting unit 36 in parallel. The second phase modulator 39 and the third light emitting unit 38 are coupled to the AC voltage source 30 in series. For example, the second phase modulator 39 and the third light emitting unit 38 are coupled between the first power node A and the second power node B in series. The second phase modulator 39 can be the phase modulators 51, 52, 53 or 54 described in the FIGS. 5A-5D. The second phase modulator 39 is configured to change the phase of a voltage provided to the third light emitting unit 38. Further, in this embodiment, the phase of the voltage provided to the third light emitting unit 38 is different from the phase of the voltages provided to the light emitting units 32 and 36.

FIG. 10B is a diagram illustrating a light emitting device 1000 of FIG. 10A according to an exemplary embodiment of the present disclosure. The voltage applied to the first light emitting unit 32 has a positive phase shift because of the first phase modulator 34. The voltage applied to the third light emitting unit 38 has a negative phase shift because of the second phase modulator 39. Therefore, since the phase of light emitting unit 32, 36 and 38 are designed to be different to each other, one of the light emitting units 32, 36 and 38 that is under the off-period (i.e., no light is emitted) can be covered by other of the light emitting units 32, 36 and 38 that are under the on-period.

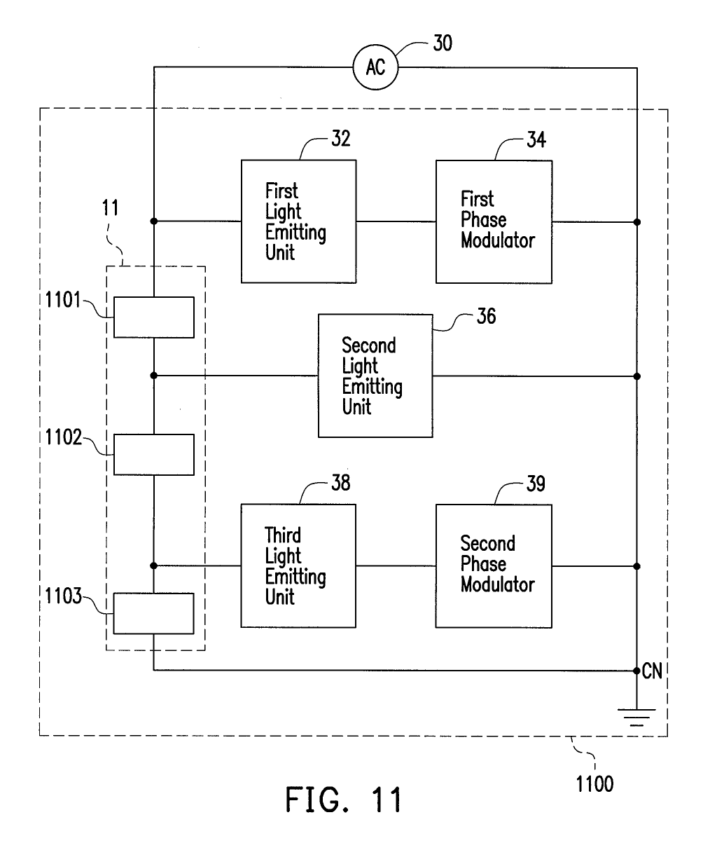

FIG. 11 is a diagram illustrating a light emitting device 1100 according to still another exemplary embodiment of the present disclosure. The light emitting device 1100 of FIG. 11 may be similar to those described or illustrated with reference to FIGS. 3, 6, 8, 9 and 10. The light emitting device 1100 further comprises a voltage divider 11 coupled between the first light emitting unit 32, the second light emitting unit 36, the third light emitting unit 38 and the AC voltage source 30. The voltage divider 11 provides voltages divided from the single-phase voltage provided from the AC voltage source 30 to the first light emitting unit 32, the second light emitting unit 36 and the third light emitting unit 38.

In FIG. 11, the voltage divider 11 has a first output end, a second output end and a third output end for providing the voltages divided from the single-phase voltage provided from the AC voltage source 30. The first light emitting unit 32 and the first phase modulator 34 are coupled between the common node CN and the first output end of the voltage divider 11 in series. The second light emitting unit 36 is coupled between the common node CN and the second output end of the voltage divider 11. The third light emitting unit 38 and the second phase modulator 39 are coupled between the common node CN and the third output end of the voltage divider 11. In this embodiment, the voltages outputted from the voltage divider 11 to the light emitting units 32, 36 and 38 may has a same level. In other embodiment, the voltages outputted from the voltage divider 11 to the light emitting units 32, 36 and 38 may be different voltage.

In one embodiment, the voltage divider 11 may comprise three impedance devices 1101, 1102 and 1103 (e.g. resistors, capacitors or inductors). For example, the impedance devices 1101, 1102 and 1103 are three capacitors. A first terminal of the first impedance device 1101 of the voltage divider 11 is coupled to the AC voltage source 30 and the first light emitting unit 32, and a second terminal of the first impedance device 1101 is coupled to the second light emitting unit 36. A first terminal of the second impedance device 1102 of the voltage divider 11 is coupled to the second terminal of the first impedance device 1101, and a second terminal of the second impedance device 1102 is coupled to the third light emitting unit 38. A first terminal of the third impedance device 1103 of the voltage divider 11 is coupled to the second terminal of the second impedance device 1102, and a second terminal of the third impedance device 1103 is coupled to the common node CN (e.g. grounded).

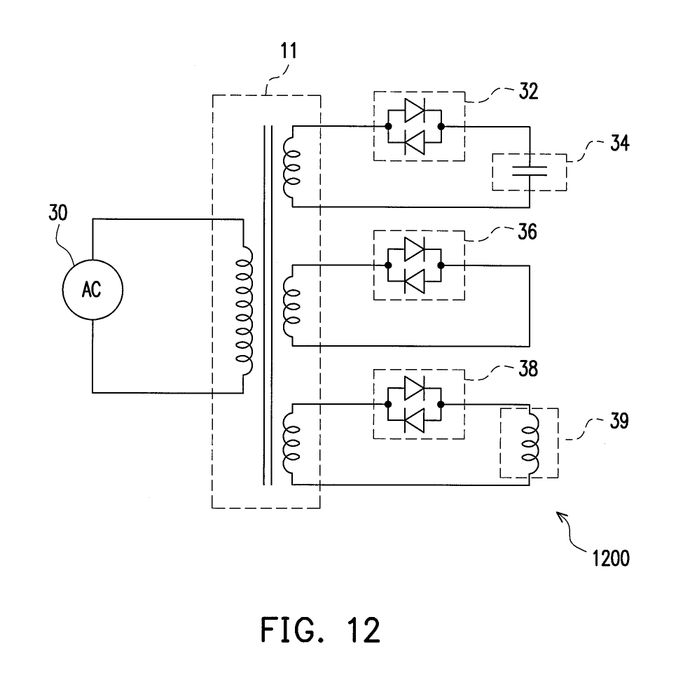

In another embodiment, the voltage divider 11 comprises a transformer for dividing the single-phase voltage provided from the AC voltage source 30. FIG. 12 is a diagram illustrating the light emitting device 1200 according to other exemplary embodiment of the present disclosure. The light emitting device 1200 may be similar to those described or illustrated with reference to FIGS. 10A and 11. The voltage divider 11 comprises a transformer having a first winding, a second winding, a third winding and a fourth winding. Two terminals of the first winding are coupled to the AC voltage source 30. The first light emitting unit 32 and the first phase modulator 34 are coupled between two terminals of the second winding in series. The second light emitting unit 36 is coupled between two terminals of the third winding. The third light emitting unit 38 and the second phase modulator 39 are coupled between two terminals of the fourth winding in series.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light emitting device comprising:
a first light emitting unit comprising at least one alternating-current (AC) light emitting diode (LED), wherein the first light emitting unit is coupled to an AC voltage source;
a second light emitting unit comprising at least one AC LED, wherein the second light emitting unit is coupled to the AC voltage source, and the second light emitting unit couples to the first light emitting unit in parallel; and
a first phase modulator, wherein the first phase modulator and the first light emitting unit couple to the AC voltage source in series, the first phase modulator is configured to change the phase of a voltage provided to the first light emitting unit, and the phase of the voltage provided to the first light emitting unit is different from the phase of a voltage provided to the second light emitting unit.

2. The light emitting device of claim 1, wherein one or both of the first light emitting unit and the second light emitting unit comprise two LEDs coupled in inverse parallel with each other.

3. The light emitting device of claim 1, wherein one or both of the first light emitting unit and the second light emitting unit comprises at least one LED bridge.

4. The light emitting device of claim 1, wherein one or both of the first light emitting unit and the second light emitting unit comprise a plurality of LED bridges coupled in parallel or in series.

5. The light emitting device of claim 1, wherein the first phase modulator comprises at least one of a capacitor or an inductor.

6. The light emitting device of claim 1, wherein the first phase modulator comprises a capacitor and an inductor coupled in series or in parallel.

7. The light emitting device of claim 1 further comprises:
a second phase modulator, wherein the second phase modulator and the second light emitting unit couple to the AC voltage source in series, and the second phase modulator is configured to change the phase of the voltage provided to the second light emitting unit.

8. The light emitting device of claim 1 further comprises:
a third light emitting unit comprising at least one AC LED, wherein the third light emitting unit is coupled to the AC voltage source, and the third light emitting unit couples to the first and the second light emitting units in parallel; and
a second phase modulator, wherein the second phase modulator and the third light emitting unit are coupled to the AC voltage source in series, the second phase modulator is configured to change the phase of a voltage provided to the third light emitting unit, and the phase of the voltage provided to the third light emitting unit is different from the phase of the voltages provided to the first and the second light emitting units.

9. The light emitting device of claim 8, wherein the third light emitting unit comprises two LEDs coupled in inverse parallel with each other.

10. The light emitting device of claim 8, wherein the third light emitting unit comprises at least one LED bridge.

11. The light emitting device of claim 8, wherein the second phase modulator comprises at least one of a capacitor or an inductor.

12. The light emitting device of claim 8, wherein the second phase modulator comprises a capacitor and an inductor coupled in series or in parallel.

13. The light emitting device of claim 8 further comprising:
a voltage divider coupled between the first light emitting unit, the second light emitting unit, the third light emitting unit and the AC voltage source, wherein the voltage divider provides voltages divided from a single-phase voltage provided from the AC voltage source to the first light emitting unit, the second light emitting unit and the third light emitting unit.

14. The light emitting device of claim 13, wherein the voltage divider comprises:
a first impedance device having a first end and a second end, wherein the first end of the first impedance device is coupled to the AC voltage source and the first light emitting unit;
a second impedance device having a first end and a second end, wherein the first end of the second impedance device is coupled to the second end of the first impedance device and the second light emitting unit; and
a third impedance device having a first end and a second end, wherein the first end of the third impedance device is coupled to the second end of the second impedance device and the third light emitting unit, and the second end of the third impedance device is grounded.

15. The light emitting device of claim 14, wherein the first, the second and the third impedance devices are resistors, capacitors or inductors.

16. The light emitting device of claim 13, wherein the voltage divider comprises:
a transformer having a first winding, a second winding, a third winding and a fourth winding, wherein two terminals of the first winding are coupled to the AC voltage source, the first light emitting unit and the first phase modulator are coupled between two terminals of the second winding in series, the second light emitting unit is coupled between two terminals of the third winding, and the third light emitting unit and the second phase modulator are coupled between two terminals of the fourth winding in series.

17. The light emitting device of claim 1 further comprising:
a voltage divider coupled between the first light emitting unit, the second light emitting unit and the AC voltage source, wherein the voltage divider provides voltages divided from a single-phase voltage provided from the AC voltage source to the first light emitting unit and the second light emitting unit.

18. The light emitting device of claim 17, wherein the voltage divider comprises:
a first impedance device having a first end and a second end, wherein the first end of the first impedance device is coupled to the AC voltage source and the first light emitting unit; and
a second impedance device having a first end and a second end, wherein the first end of the second impedance device is coupled to the second end of the first impedance device and the second light emitting unit, and the second end of the second impedance device is grounded.

19. The light emitting device of claim 18, wherein the first and the second impedance devices are resistors, capacitors or inductors.

20. The light emitting device of claim 17, wherein the voltage divider comprises:
a transformer having a first winding, a second winding and a third winding, wherein two terminals of the first winding are coupled to the AC voltage source, the first light emitting unit and the first phase modulator are coupled between two terminals of the second winding in series, and the second light emitting unit is coupled between two terminals of the third winding.
